(19) United States
(12) Patent Application Publication
(10) Pub. No.: US 2024/0302279 A1
(43) Pub. Date: Sep. 12, 2024

(54) OPTOCHEMICAL SENSOR AND METHOD FOR MEASURING LUMINESCING ANALYTES IN A MEASUREMENT MEDIUM

(71) Applicant: Endress+Hauser Conducta GmbH+Co. KG, Gerlingen (DE)

(72) Inventors: Andreas Löbbert, Waldheim (DE); Katrin Scholz, Bobritzsch (DE); Ralf Bernhard, Stuttgart (DE)

(21) Appl. No.: 18/258,750

(22) PCT Filed: Nov. 18, 2021
(86) PCT No.: PCT/EP2021/082179

§ 371 Date: Jun. 21, 2023

(30) Foreign Application Priority Data
Dec. 21, 2020 (DE) 10 2020 134 423.6
Feb. 3, 2021 (DE) 10 2021 102 505.2

(51) Int. Cl. G01N 21/64; G01N 21/85

(52) U.S. Cl. CPC G01N 21/643; G01N 21/645; G01N 21/8507; G01N 2021/6439; G01N 2021/6463; G01N 2021/6484

(57) ABSTRACT

An optochemical sensor for measuring luminescing analytes in a measurement medium includes a sensor housing, a light source, a functional element, a photodetector and a control unit, wherein the sensor housing includes a window suitable for coming into contact with the measurement medium, wherein the light source is configured to emit a stimulation signal in such a way that the stimulation signal is partially emitted onto the functional element and the stimulation signal is partially emitted through the window into the measurement medium as to stimulate a first analyte present in the measurement medium, wherein the functional element includes a reference dye that includes an inorganic material and is suitable for emitting a first luminescence signal upon stimulation with the first stimulation signal.

The invention relates to an optochemical sensor for measuring luminescing analytes in a measurement medium and to a method for measuring luminescing analytes in a measurement medium.

In analytical measurement technology, especially, in the fields of water management, of environmental analysis, in industry, e.g., in food technology, biotechnology, and pharmaceutics, as well as for the most varied laboratory applications, measurands, such as the pH value, the conductivity, or even the concentration of analytes, such as ions or dissolved gases in a gaseous or liquid measurement medium, are of great importance. These measurands can be detected, for example, by means of optochemical or optical sensors.

If a measurement medium is to be analyzed for the presence of oil or algae, the measurement medium is usually analyzed by means of an optical sensor. The optical sensor emits a light signal of a predetermined wavelength into the measurement medium. Because oil and algae emit a fluorescent light signal when excited with a specific light signal, such a fluorescent light signal can be detected by means of a photodetector. Depending on the detected fluorescent light signal, the concentration of the oil or algae in the measurement medium can then be deduced.

However, the light signal emitted into the measurement medium must be sufficiently intense to stimulate the oil or algae in such a way to emit a fluorescent light that can be detected by the photodetector. Of course, the intense excitation signal is also associated with a correspondingly high power consumption by the light source.

In some industrial applications, however, the power consumption of sensors is limited to a predetermined level so that the emission of intense excitation signals is not possible.

It is therefore an object of the invention to provide a sensor that can be used in a versatile manner and allows the measurement of luminescing analytes of a measurement medium in a reliable and precise manner.

This object is achieved according to the invention by the optochemical sensor according to claim 1.

The optochemical sensor according to the invention comprises a sensor housing, a light source, a functional element, a photodetector and a control unit. The sensor housing has a window that is suitable for coming into contact with the measurement medium. The light source is configured to emit a stimulation signal in such a way that the stimulation signal is at least partially emitted onto the functional element and the stimulation signal is at least partially emitted through the window into the measurement medium in order to stimulate a first analyte present in the measurement medium. The functional element has a reference dye that comprises an inorganic material and is suitable for emitting a first luminescence signal upon stimulation with the first stimulation signal. The photodetector is configured to detect the first luminescence signal and to detect a second luminescence signal emitted by the first analyte present in the measurement medium and superimposed with the first luminescence signal. The control unit is connected to the light source and to the photodetector, and is suitable for controlling the light source and evaluate the luminescence signals detected by the photodetector.

The optochemical sensor according to the invention makes it possible to achieve a signal superposition of the luminescence signal emitted by the measurement medium, more precisely a fluorescence signal, and the luminescence signal emitted by the reference dye, more precisely a phosphorescence signal, which ultimately leads to the provision of a measurement signal that is sufficiently intense for the photodetector. The sensor thus makes it possible to stimulate the reference dye and the fluorescent analyte present in the measurement medium and to detect the luminescence signal thereof.

Thus, the measurement makes it possible not only to detect the presence of oil, water emulsions or algae, but also to be able to distinguish between, for example, different algae species and to determine their concentration in the measurement medium. In addition, individual parameters such as pH, CO₂, oxygen, cations, anions, organic substances such as glucose or lactose can also be optically measured individually or also in parallel.

According to one embodiment of the invention, the control unit comprises a memory having a table or a mathematical function. The control unit is suitable for determining the analyte content of the first analyte located in the measurement medium and/or identify the first analyte based on the first luminescence signal, the second luminescence signal, and the table or the mathematical function and stored coefficients.

According to one embodiment of the invention, the functional element is transparent and the reference dye is arranged in the functional element in such a way that at least 10%, even more preferably 30% and most preferably 50% of the first stimulation signal passes the reference dye.

According to one embodiment of the invention, the functional element is arranged in the window in such a way that the functional element is suitable for coming into contact with the measurement medium. The functional element has an indicator dye (see also, for example, file reference: DE102019133805.0, DE102020134517.8 or DE102020134515.1) that comprises an organic material and is suitable for emitting a third luminescence signal upon stimulation with the first stimulation signal. In the emission of the third luminescence signal, the indicator dye can be influenced by a second analyte present in the measurement medium.

According to one embodiment of the invention, the functional element is partially coated with a reflection layer in such a way that the stimulation signal can be reflected back into the functional element in the direction of the reflection layer upon leaving the functional element.

According to one embodiment of the invention, the sensor housing is partially coated with a reflection layer and is designed in such a way that the measurement medium can be arranged between the window and the reflection layer.

The above-mentioned object is also achieved by a method for measuring luminescing analytes in a measurement medium according to claim 7.

The method according to the invention comprises at least the following steps:
providing an optochemical sensor according to the invention, which is in contact with a measurement medium, wherein at least one first analyte is present in the measurement medium,
controlling the light source by means of the control unit so that a stimulation signal is emitted onto the functional element and into the measurement medium in order to stimulate the reference dye and the first analyte present in the measurement medium,
detecting the first luminescence signal emitted by the reference dye and the second luminescence signal emitted by the at least first analyte and superimposed with the first luminescence signal by means of the photodetector.

According to one embodiment of the invention, the control unit comprises a memory having a table or a mathematical function. The method further comprises a step of evaluating the first luminescence signal and the second luminescence signal by means of the table or mathematical function stored in the memory of the control unit in order to determine the analyte content of the first analyte located in the measurement medium and/or to identify the first analyte.

According to one embodiment of the invention, the functional element is arranged in the window in such a way that the functional element is suitable for coming into contact with the measurement medium. The functional element has an indicator dye that comprises an organic material and is suitable for emitting a first luminescence signal upon stimulation with the third stimulation signal. In the emission of the third luminescence signal, the indicator dye can be influenced by a second analyte present in the measurement medium. During the step of controlling the light source by means of the control unit, the stimulation signal also stimulates the indicator dye present in the functional element. The step of detecting further comprises detecting a third luminescence signal emitted by the indicator dye by means of the photodetector.

According to one embodiment of the invention, the method further comprises a step of evaluating the third luminescence signal by means of the table or mathematical function stored in the memory of the control unit in order to determine the analyte content of the second analyte located in the measurement medium and/or to identify the second analyte. The invention is explained in more detail on the basis of the following description of the figures. In the figures:

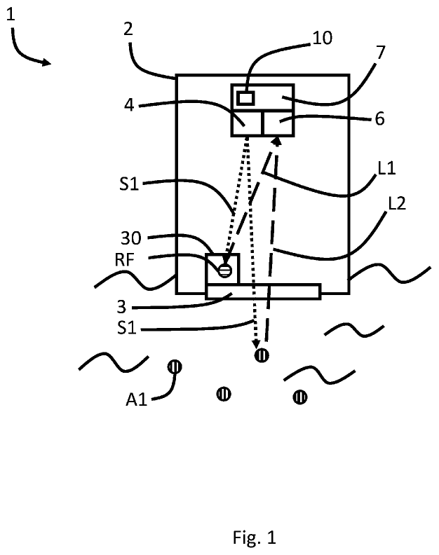

FIG. 1: shows an embodiment of the optochemical sensor according to the invention,

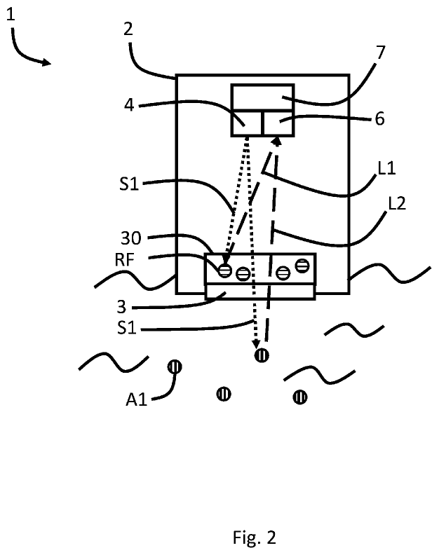

FIG. 2: shows a further embodiment of the electrochemical sensor shown in FIG. 1;

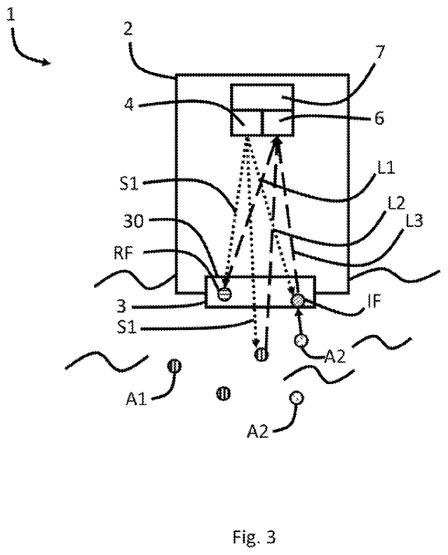

FIG. 3: shows an alternative embodiment of the optochemical sensor shown in FIG. 1 with an additional indicator dye,

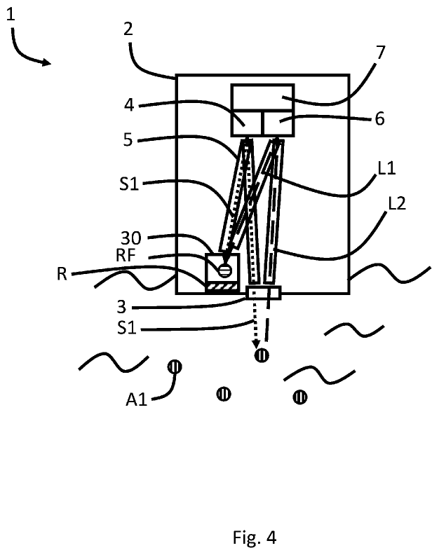

FIG. 4: shows an alternative embodiment of the optochemical sensor shown in FIG. 1 with a reflection layer for amplification of the first luminescence signal,

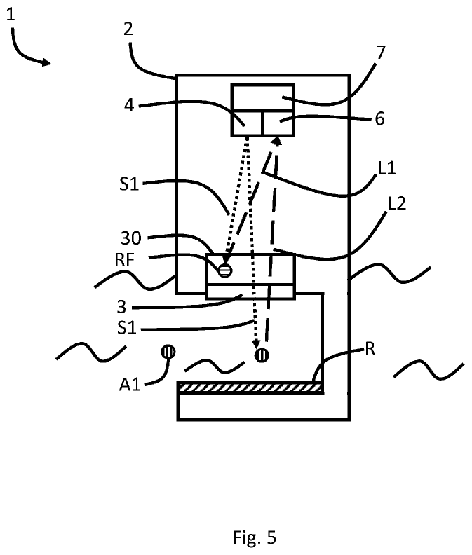

FIG. 5: shows an alternative embodiment of the optochemical sensor shown in FIG. 1 with a reflection layer for amplification of the second luminescence signal.

The optochemical sensor 1 according to the invention comprises a sensor housing 2, a light source 4, a functional element 30, a photodetector 6 and a control unit 7, as shown by way of example in FIG. 1.

The sensor housing 2 has a window 3 that is suitable for coming into contact with the measurement medium. The window 3 is, for example, made of glass, plastic, sapphire or another transparent material. The material is permeable to both excitation light and emission light. As explained further below, the functional element 30 can be arranged in the window 3 according to one embodiment of the optochemical sensor 1.

The light source 4 is adapted to emit a stimulation signal S1. The stimulation signal S1 preferably has a wavelength in the near infrared range or between 200 nm and 650 nm. The light source 4 is, for example, an LED, an alternating LED or an array of a plurality of LEDs. The light source 4 can also comprise one or more lasers. In the case of multiple LEDs, the light emitted by the different LEDs preferably has different wavelengths. The stimulation signal S1 can preferably be generated by the light source 4 in such a way that the wavelength, the duration, the signal form and the frequency of the first stimulation signal S1 are adjustable. For example, the stimulation signal S1 is a pulse having a predetermined duration and strength.

The light source 4 is arranged in such a way that the stimulation signal S1 is partially emitted onto the functional element 30 and is partially emitted through the window 3 into the measurement medium. By emitting the first stimulation signal S1 into the measurement medium, it is possible to stimulate a first analyte A1 present in the measurement medium. In order to achieve such simultaneous stimulation of the functional element 30 and of the measurement medium, the light source 4 emits the stimulation signal S1, for example, at a sufficiently wide angle or is emitted by multiple light sources 4. Alternatively or complementary thereto, the stimulation signal S1 can also be guided by means of an optical waveguide from the light source 4 onto the functional element 30 and into the measurement medium. The optical waveguide 5 is discussed in more detail later. The light source 4 can also have a filter unit in order to ensure, for example, that the stimulation signal S1 has a predetermined wavelength.

The functional segment 30 has a reference dye RF. The reference dye RF comprises an inorganic material that emits a first luminescence signal L1 upon stimulation with the first stimulation signal S1. The first luminescence signal L1 is preferably a phosphorescence signal.

The reference dye RF is not analyte-sensitive, i.e., is not influenced by the presence of an analyte in the measurement medium during the emission of the first luminescence signal L1. The reference dye RF preferably has a particle size between 5 μm and 20 μm or a particle size greater than 20 μm, particularly preferably greater than 50 μm. The first luminescence signal L1 emitted by the reference dye RF preferably has a decay time between 0.1 μs and 500 μs.

The functional element 30 can be attached in the window 3 and/or on the surfaces of the window 3 and/or be attached in an optical waveguide 5 and/or at the interfaces of the optical waveguide 5 and/or on a surface of the sensor housing 2 that is in contact with the measurement medium and can be stimulated by the stimulation signal S1.

In a particular embodiment, the optical waveguide 5 contains the reference dye RF. In this case, the reference dye RF can cover the surface of the optical waveguide 5 or else be located in the optical waveguide 5 itself. In this case, the functional element 30 is part of the optical waveguide 5. This preferably applies to the fiber(s) of the optical waveguide 5, which extend(s) from the light source 4 to the measurement medium or to the reflection layer R. The branch of the optical waveguide 5, which leads from the measurement medium to the photodetector 6, preferably has no reference dye RF.

In the embodiment in which the reference dye RF partially or completely covers at least one surface of the window 3 as a coating, the reference dye RF preferably has a particle size greater than 5 μm, preferably greater than 20 μm and most preferably greater than 50 μm. This coating can completely cover the surface of the window 3 when it is still transparent to the light emitted by the light source 4 and the light emitted by the reference dye RF. This is the case with high emitting dyes and with thin coating thicknesses, i.e., between 1 nm and 500 nm, preferably with coating thicknesses between 1 nm and 50 nm. In this case, “coating” is understood to mean the functional layer 30 that is applied to a surface, in this case the window 3.

Preferably, the coating allows the stimulation signal S1 to excite the reference dye RF, an analyte present in the measurement medium, and an indicator dye IF attached to or in the window 3 (substrate), and the resulting (total) signal can be detected by the photodetector 6. Ideally, the reference dye RF is located between light source 4 and the measurement medium. The optical waveguide 5 preferably has an optical fiber in the form of a Y-bundle, which is suitable for capturing the luminescence signals.

The reference dye RF preferably contains at least one of the following substances: Garnets such as (Y,Gd,Tb)₃Al₅O₁₂:Ce³⁺, orthosilicates such as (Ca,Sr,Ba)₂SiO₄:Eu²⁺, Ba₂SiO₄:Eu₂₊, GalnNs such as chromium-doped inorganic compounds such as Ga₂O₃Cr³⁺, GAB:Cr, YAB:Cr, YAB:Ho,Nd, YAB:Nd,Cr, YAB:Ho,Nd,Cr, fluorides such as KMgF₃:Eu²⁺, borates such as SrB₄O₇:Eu²⁺, phosphates such as SrP₂O₇:Eu²⁺, sulphates such as BaSO₄:Eu²⁺, aluminates such as BaMgAl₁₀O₁₇:Eu²⁺, Sr₄Al₁₄O₂₅:Eu²⁺; SrAl₂O₄: Eu²⁺, SrSiAl₂O₃N:Eu²⁺, sulfides such as SrGa₂S₄Eu²⁺, SrSi₂N₂O₂:Eu²⁺. Where Cr-GAB stands for chromium-doped gadolinium aluminum borates and Cr-YAB stands for chromium-doped yttrium aluminum borates. The element responsible for luminescence is behind the colon.

The photodetector 6 is configured to detect the first luminescence signal L1 emitted by the reference dye RF in the functional element 30. Furthermore, the photodetector 6 is suitable for detecting a second luminescence signal L2 that comes about by superimposing the first luminescence signal L1 and a luminescence signal emitted by the first analyte A1. The photodetector 6 is, for example, a photodiode, an array of photodiodes, a CCD camera, a spectrometer or another photosensitive element. The photodetector 6 is arranged in such a way that the first luminescence signal L1 and the second luminescence signal L2 are detectable by the photodetector 6. For example, the optical waveguide 5 is designed in such a way that the first luminescence signal L1 can be conducted from the functional element 30 to the photodetector 6 and the second luminescence signal L2 can be conducted from the measurement medium to the photodetector 6. The photodetector 6 can also have filter elements that filter out, for example, disturbing ambient light or other parasitic light.

The control unit 7 is connected to the light source 4 and the photodetector 6. The control unit 7 controls the light source 4 so that a predetermined stimulation signal S1 having a predetermined wavelength, signal form, frequency and duration is emitted. Furthermore, the control unit 7 evaluates the first and second luminescence signals L1, L2 detected by the photodetector 6.

According to one embodiment, the control unit 7 has a memory 10. A table or one or more mathematical functions and coefficients are stored in the memory 10. The table preferably contains information regarding the signal properties of various luminescence signals emitted by algae or oils. The mathematical function or the mathematical functions preferably describe the signal forms of the luminescence signals emitted by various algae or oils.

The control unit 7 is suitable for evaluating mixed signals, i.e., mixed luminescence signals, and individual signals. The signals are uniquely assigned to a specific type of analyte and/or a specific analyte concentration by the control unit 7. This assignment takes place for example by:
a) spatial separation of the luminescence signals (by means of different excitation LEDs or LED arrays),
b) temporal separation of the luminescence signals (using a measurement clock or a measurement pulse or a modulation frequency),
c) spectral separation of the luminescence signals (using a grating and/or a prism in front of the photodiode(s) or CCD camera).

Furthermore, it is possible to excite or measure with different modulation frequencies and/or measurement clock frequencies and/or measurement pulse frequencies and/or time interval measurements. The parameters can be constant or variable. Alternating measurements with different parameter values are also possible. The decay time, phase shift or also intensity measurements with stray light correction are suitable for evaluation.

The control unit 7 is suitable for determining the analyte content of the first analyte A1 located in the measurement medium based on the first luminescence signal L1, the second luminescence signal L2, and the table or the mathematical function. It is also possible to quantify and/or identify the type of algae or oil in the medium by comparing the detected second luminescence signal with the luminescence signals stored in the table. Using the function or functions stored in the memory 10, it is also possible for the control unit 7 to quantify and/or identify different algae or oils in the measurement medium.

FIG. 2 shows an embodiment of the optochemical sensor 1 with a transparent functional element 30. In this case, the functional element 30 is arranged here between the light source 4 and the window 3 and between the photodetector 6 and the window 3. In this case, the reference dye RF is arranged in the functional element 30 in such a way that 90%, 70% or 50% of the first stimulation signal S1 strikes the reference dye RF, i.e., stimulates the reference dye RF. The portions of the first stimulation signal S1 that do not stimulate the reference dye RF preferably traverse the functional element 30 in order to stimulate the first analyte A1 present in the measurement medium. For example, a pH of the measurement medium or a CO₂ content of the measurement medium can be derived from the first analyte A1.

FIG. 3 shows a further embodiment of the optochemical sensor 1, in which the functional element 30 is arranged in the window 3. The functional element 30 is arranged in the window in such a way that the functional element 30 is suitable for coming into contact with the measurement medium. In this embodiment, the functional element 30 has an indicator dye IF in addition to the reference dye RF. The indicator dye IF comprises an organic material and is suitable for emitting a third luminescence signal L3 upon stimulation with the first stimulation signal S1. The indicator dye IF is sensitive with respect to a second analyte A2, for which reason the indicator dye IF should come into contact with the measurement medium. During the emission of the third luminescence signal L3, the indicator dye IF can therefore be influenced by the second analyte A2 present in the measurement medium (shown in FIG. 3 by an arrow between the second analyte A2 and the indicator dye IF). The second analyte A2 comprises, for example, an oxygen molecule or another substance present in the measurement medium. The third luminescence signal L3, for example, is a fluorescence signal. Of course, the reference dye RF in this embodiment can also be arranged outside the window 3 because contact with the measurement medium is not of interest for the reference dye RF. The functional element 30 having the reference dye RF can thus also be arranged on an optical waveguide 5 or elsewhere in the sensor housing 2, assuming that the reference dye RF can be stimulated by the stimulation signal S1.

FIG. 4 shows a further embodiment of the optochemical sensor 1 in which the functional element 30 is partially coated with a reflection layer R. The reflection layer R is applied to the functional element 30 or delimits the functional element 30 in such a way that the stimulation signal S1 can be reflected back into the functional element 30 in the direction of the reflection layer R upon leaving the functional element 30. Stronger stimulation of the reference dye RF in the functional element 30 is thus achieved. In all embodiments, an optical waveguide 5, for example a Y-shaped optical waveguide 5, can be used to guide the stimulation signal S1, the first luminescence signal L1, the second luminescence signal L2 and the third luminescence signal L3.

FIG. 5 shows a modified form of the optochemical sensor 1 shown in FIG. 4. In this case, the reflection layer R is attached to the sensor housing 2 in such a way that the portion of the first stimulation signal S1, which was emitted into the measurement medium, is reflected back from the measurement medium back into the optochemical sensor 1. In this case, for example, the sensor housing 2 is partially coated with a reflection layer R and is, for example, partially U-shaped, so that the measurement medium can be arranged between the window 3 and the reflection layer R. In this embodiment, a first analyte A1 present in the measurement medium is more strongly stimulated by the stimulation signal S1, which generates a stronger second luminescence signal L2. Instead of the reflection layer R, the functional layer 30 could also be arranged on the sensor housing 2 or be arranged thereon in addition to the reflection layer R. An optical path traversed by the stimulation signal S1 thus ends in the functional layer 30. The functional layer 30 would thus be arranged virtually in the measurement medium or behind the measurement medium, at least from the point of view of the photodetector 6.

All the embodiments of the optochemical sensor 1 described above can be combined with one another, provided that this is technically possible.

The method for measuring luminescing analytes in a measurement medium by means of the optochemical sensor 1 mentioned above is described below.

In a first step, the optochemical sensor 1 is provided in a state that is ready for measurement. This means that the optochemical sensor 1 is in contact with the measurement medium. Of course, at least the first analyte A1 is also present in the measurement medium.

Next, the light source 4 is controlled by the control unit 7, so that the stimulation signal S1 is emitted onto the functional element 30 and into the measurement medium. As a result, the reference dye RF present in the functional element 30 and the first analyte A1 located in the measurement medium are stimulated. Due to the stimulation with the stimulation signal S1, the reference dye RF emits the first luminescence signal L1. Likewise, the first analyte A1 emits a luminescence signal superimposed with the first luminescence signal L1 to form a second luminescence signal L2.

Then the first luminescence signal L1 and the second luminescence signal L2 are detected by the photodetector 6.

The control unit 7 evaluates the detected signals by means of the dual lifetime referencing method, whereby the original signal component of the second luminescence signal L2, which was emitted by the first analyte A1, can be determined.

The control unit 7 preferably has a memory 10 having a table or a mathematical function, or multiple mathematical functions. Coefficients used by the mathematical function are also stored in the memory 10.

The method advantageously further comprises a step of evaluating the first luminescence signal L1 and the second luminescence signal L2 by means of the table or mathematical function stored in the memory 10 of the control unit 7. This makes it possible to determine the analyte content of the first analyte A1 present in the measurement medium and/or to identify the first analyte A1. For this purpose, the signal component of the second luminescence signal L2, which was emitted by the first analyte A1, is extracted and compared with luminescence information that is stored in the table or described by the mathematical function or functions and based on stored coefficients. Thus, a quantification and or an identification of the first analyte A1 can then take place.

When the functional element 30 is, as shown in FIG. 3, arranged in the window 3 in such a way that the functional element 30 is suitable for coming into contact with the measurement medium and the functional element 30 has the indicator dye IF, the stimulation signal S1 is emitted from the light source 4 in the step of emitting the first stimulation signal S1 in such a way that the indicator dye IF is also stimulated in addition to the reference dye RF.

The indicator dye IF then emits the third luminescence signal L3. The third luminescence signal L3 is captured in the optochemical sensor 1 through the window 3 in order to be detected by the photodetector 6. If the optochemical sensor 1 has an optical waveguide 5, said optical waveguide guides the third luminescence signal L3 to the photodetector 6.

In this case, the third luminescence signal L3 is thus also detected by means of the photodetector 6 in the step of detecting.

When the control unit 7 evaluates the detected luminescence signals, the third luminescence signal L3 is of course also evaluated. The evaluation of the third luminescence signal L3 takes place, for example, by comparing it with luminescence signals stored in the table, in particular their decay behavior after a stimulation pulse.

Instead of the table, the mathematical function or different functions can also be used to determine the analyte content of the second analyte A2 present in the measurement medium and/or to identify the second analyte A2.

In all embodiments of the method, the stimulation signal S1 can also be generated by two or more LEDs of the light source 4. In this case, each LED preferably has a different wavelength, so that the stimulation signal S1 consists of two superimposed partial signals.

For example, when using multiple LEDs that each emit radiation at different wavelengths, a phytocyanine present in the measurement medium can be stimulated by means of orange radiation and a phycoerythrin present in the measurement medium can be stimulated by means of green radiation. Any chlorophyll present in the measurement medium can also be excited by the emission light of the phytocyanine/phycoerythrin. The chlorophyll can preferably also be stimulated by a blue light emitted by the light source 6. A time-shifted luminescence signal emitted by the chlorophyll can thus be detected. The measured values of the chlorophyll concentration and the other components can then be calculated by means of the control unit 7 using stored functions.

In all embodiments of the method, the evaluation can also take place by means of a combination of decay time of the luminescence signals and of the phase angle difference between the stimulation signal S1 and the luminescence signals L1, L2.

In all embodiments of the method, the light source 4 is preferably controlled in such a way that it absorbs less than 0.3 W of electrical energy.

According to one embodiment, the functional element 30 has a thickness of 1 nm to 500 nm.

According to one embodiment of the invention, the functional element 30 is arranged between the light source 4 and the measurement medium M and/or the reflection layer R.

According to one embodiment of the invention, the functional element 30 is transparent and the reference dye RF is arranged in the functional element 30 in such a way that at least 10%, even more preferably 30% and most preferably 50% of the first stimulation signal S1 passes the reference dye RF. The window 3 is preferably made of a non-continuous coating, i.e., the functional element 30, which coating is covered with reference dye particles greater than 5 μm, even more preferably greater than 20 μm and most preferably greater than 50 μm. The functional element 30 is preferably arranged between the light source 4 and the measurement medium M and/or the reflection layer R.

According to one embodiment of the invention, the functional element 30 consists of at least one optical waveguide fiber doped with the reference dye or an externally coated fiber.

According to one embodiment of the invention, the functional element 30 has at least one reference dye RF having an emitted wavelength range of greater than or equal to 100 nm, even more preferably of greater than 200 nm and most preferably of greater than 300 nm.

The functional element 30 is arranged in the optical path of the stimulation signal S1 emitted by the light source 4.

All objects passed by the stimulation signal S1 on the optical path preferably have the same or similar refractive index. If the refractive index is not similar, the distance must be kept low.

In this case, low means a few millimeters.

The optical path has an excitation path from the light source 4 to the analyte, as well as an emission path from the analyte to the photodetector 6.

The functional element 30 contains the reference dye RF, which is phosphorescent and has a decay time of preferably between 1 μs and 500 μs. The functional element 30 is arranged in the excitation path.

The reference dye RF can also comprise mixtures of different substances.

Chemical and physical measurands are possible:
a) chemical measurands are realized exclusively by means of fluorescent substances
b) physical measurands can be realized with both fluorescent and phosphorescent substances.

The reference dye is generally phosphorescent.

The term “interference light” is understood to mean light that was not emitted by the analyte as fluorescent light or phosphorescent light and therefore does not depend on the parameters to be measured.

According to one embodiment of the measuring method, a parallel separate fluorescence measurement of at least one further analyte can be carried out. This is a combination sensor consisting of simple fluorescence measurement and the invention.

### LIST OF REFERENCE SIGNS

1 optochemical sensor
2 sensor housing
3 window
4 light source
5 optical waveguide
6 photodetector
7 control unit
10 memory
30 functional element
S1 stimulation signal
L1 first luminescence signal
L2 second luminescence signal
L3 third luminescence signal
IF indicator dye
RF reference dye
R reflection layer
A1 first analyte
A2 second analyte

1-10. (canceled)

11. An optochemical sensor for measuring luminescing analytes in a measurement medium, the optoelectronic sensor comprising:
a sensor housing, wherein the sensor housing includes a window adapted to contact the measurement medium;
a functional element, wherein the functional element includes a reference dye comprising an inorganic material and suitable for emitting a first luminescence signal upon stimulation with light;
a light source, wherein the light source is configured to emit a stimulation signal such that the stimulation signal is at least partially emitted onto the functional element and the stimulation signal is at least partially emitted through the window into the measurement medium as to stimulate a first analyte present in the measurement medium, wherein the function element emits the first luminescence signal upon stimulation with the first stimulation signal;
a photodetector, wherein the photodetector is configured to detect the first luminescence signal and to detect a second luminescence signal emitted by the first analyte present in the measurement medium and superimposed with the first luminescence signal; and
a control unit, wherein the control unit is connected to the light source and the photodetector and is configured to control the light source and evaluate the first and second luminescence signals detected by the photodetector.

12. The optoelectronic sensor according to claim 11, wherein the control unit comprises a memory, including a table or a mathematical function stored therein, and
wherein the control unit is configured to determine an analyte content of the first analyte present in the measurement medium and/or to identify the first analyte based on the first luminescence signal, the second luminescence signal, the table or the mathematical function, and stored coefficients.

13. The optoelectronic sensor according to claim 11, wherein the functional element is transparent, and the reference dye is disposed in the functional element such that at least 10% of the first stimulation signal passes the reference dye.

14. The optoelectronic sensor according to claim 13, wherein the reference dye is disposed in the functional element such that at least 50% of the first stimulation signal passes the reference dye.

15. The optoelectronic sensor according claim 11, wherein the functional element is arranged in the window such that the functional element is adapted to contact the measurement medium,
wherein the functional element includes an indicator dye comprising an organic material and adapted to emit a third luminescence signal upon stimulation with the first stimulation signal, and
wherein the indicator dye is adapted to be influenced by a second analyte present in the measurement medium during the emission of the third luminescence signal.

16. The optoelectronic sensor according to claim 11, wherein the functional element is partially coated with a reflection layer such that the stimulation signal is reflected back into the functional element in the direction of the reflection layer upon leaving the functional element.

17. The optoelectronic sensor according to claim 11, wherein the sensor housing is partially coated with a reflection layer and is configured such that the measurement medium is disposed between the window and the reflection layer in operation of the optoelectronic sensor.

18. A method for measuring luminescing analytes in a measurement medium using an optochemical sensor, the method comprising:
providing the optochemical sensor according to claim 11;
contacting a measurement medium with at least the window of the optochemical sensor, wherein at least one analyte is present in the measurement medium;
controlling the light source using the control unit such that a stimulation signal is emitted onto the functional element and into the measurement medium as to stimulate the reference dye and the at least one analyte present in the measurement medium; and
detecting the first luminescence signal emitted by the reference dye and the second luminescence signal emitted by the at least one analyte and superimposed with the first luminescence signal using the photodetector.

19. The method according to claim 18, wherein the control unit comprises a memory, including a table or a mathematical function stored therein,
wherein the method further comprises evaluating the first luminescence signal and the second luminescence signal via the table or mathematical function stored in the memory of the control unit as to determine a first analyte content of the at least one analyte present in the measurement medium and/or to identify the at least one analyte.

20. The method according to claim 18, wherein:
the functional element is arranged in the window such that the functional element is adapted to contact with the measurement medium;
the functional element includes an indicator dye comprising an organic material, which is suitable for emitting a third luminescence signal upon stimulation with the first stimulation signal, wherein the indicator dye is adapted to be influenced by a second analyte of the at least one analyte present in the measurement medium during the emission of the third luminescence signal;
during the controlling the light source by the control unit, the stimulation signal also stimulates the indicator dye present in the functional element; and
the detecting of the first and second luminescence signals further comprises detecting the third luminescence signal emitted by the indicator dye using the photodetector.

21. The method according to claim 20, wherein the method further comprises evaluating the third luminescence signal via the table or mathematical function stored in the memory of the control unit as to determine a second analyte content of the second analyte present in the measurement medium and/or to identify the second analyte.
